(19) United States
(12) Patent Application Publication
(10) Pub. No.: US 2009/0281658 A1
(43) Pub. Date: Nov. 12, 2009

(54) MEDICAL FACILITY AND METHOD OF DOCKING A POSITIONING DEVICE WITH A SHUTTLE

(76) Inventors: Stefan HÜTTENBERGER, Schardenberg (AT); Eike Rietzel, Darmstadt (DE); Matthias Saar, Altendorf (DE)

Correspondence Address: BRINKS HOFER GILSON & LIONE, P.O. BOX 10395, CHICAGO, IL, 60610, US

(21) Appl. No.: 12/421,905

(22) Filed: Apr. 10, 2009

(30) Foreign Application Priority Data
Apr. 16, 2008 (DE) 10 2008 019 114.0

(51) Int. Cl. G06F 19/00

(52) U.S. Cl. 700/245

(57) ABSTRACT

A medical facility having a room in which a shuttle may be disposed is provided. The shuttle may include a support device and a carrying device for the support device. The medical facility may include a positioning device designed for docking with the shuttle and a control unit for controlling the positioning device. The medical facility may also include a position detection system for determining the spatial position of the shuttle in the room. The control unit is operable to control the positioning device during docking with the shuttle based on the determined position.

This patent document claims the benefit of DE 10 2008 019 114.0, filed Apr. 16, 2008, which is hereby incorporated by reference.

### BACKGROUND

The present embodiments relate to docking a positioning device with a shuttle.

Particle therapy is an established method of treating tissue, such as tumor diseases. Particles may be ions, such as protons, carbon ions, or other kinds of ions. The particles may be accelerated to high energies in an accelerator, formed into a particle beam, and then directed in a treatment room onto the tissue that is to be irradiated. The particles may release energy in a relatively circumscribed area within the target volume.

It is comparatively complex and cost-intensive to accelerate particles to the required energy and form the particles into a beam. In order to operate a particle therapy facility, a treatment room of the particle therapy facility is used exclusively for a concrete irradiation procedure or an examination room of the particle therapy facility is used exclusively to carry out an examination, for example, using a computed tomography (CT) scanner.

The preparation or aftercare of the patient is conventionally carried out in a separate room. After successful preparation, for example, by immobilizing the patient on a patient table in a specially provided immobilization room, the patient table is moved using a mobile shuttle into the respective room for treatment and/or examination. After the examination and/or treatment, the patient is immediately moved out of the examination and/or treatment room, thereby making the rooms available for the next patient.

A mobile shuttle may include a patient support device and a mobile carrying device. The patient support device may be, for example, a patient table or a patient chair. The patient support device may be mounted on the mobile carrying device, so that the mobile shuttle may be moved from one room into another.

In an examination room and/or in a treatment room, the prepared patient is left on the patient support device and the patient support device is suitably positioned in the examination room and/or in the treatment room using a positioning device, for example, by a robot arm.

Alternatively, quality assurance (QA) phantoms may be mounted on a support device and removed from a carrying device. To carry out the QA measure, the robot arm may remove the support device with the QA phantoms and position support device in an appropriate manner in the room.

To provide a correct interaction between the robot arm and the shuttle, it has previously been necessary to position the shuttle and/or the support device exactly by hand and to take care that the shuttle or part of the shuttle, such as the support device or the carrying device, is not inadvertently displaced.

### SUMMARY AND DESCRIPTION

The present embodiments may obviate one or more of the drawbacks or limitations inherent in the related art. For example, in one embodiment, a medical facility, in which a docking operation of a positioning device with a shuttle may be carried out safely and at the same time with a high degree of flexibility and comfort. In another example, a method of docking the positioning device with a shuttle is provided. The method allows a high degree of safety combined with a high level of comfort and flexibility.

In one embodiment, a medical facility includes a room, in which a shuttle is disposed. The shuttle may include a support device and a carrying device for the support device. A patient or one or more quality assurance (QA) phantoms may, for example, be supported on the support device. Disposed in the room is a positioning device that is designed to dock with the shuttle, so that the support device may be removed from the carrying device and/or loaded onto the carrying device and may be brought into a predetermined position.

The medical facility may include a position detection system. The spatial position of the shuttle or parts of the shuttle in the room may be determined using the position detection system. A control unit may control the positioning device. The control unit may be designed in such a way that the positioning device, during the docking of a shuttle, is automatically controlled based on the determined position.

The medical facility may be embodied as a particle therapy facility. The room of the medical facility may be, for example, a treatment room of the particle therapy facility or an examination room. A computed tomography (CT) scan may be carried out to check the spatial position of the organs that are to be irradiated. The CT scan may be performed in the room of the medical facility.

A docking operation of the positioning device with the shuttle may be carried out when the positioning device, for example, grips the support device and removes it from the carrying device of the shuttle. In other words, the docking operation may include the positioning device docking with the support device. A docking operation is carried out also when the support device, which has already been gripped by the positioning device, is placed back onto the carrying device of the shuttle. The positioning device may then be separated (undocked) from the support device. The shuttle may be part of the medical facility.

The shuttle may be mobile. The carrying device may be of a mobile design, so that the shuttle as a whole may be moved, for example from one room into another room. In other words, the mobile carrying device and the support device may be moved, for example, from one room into another room.

The shuttle may not be mobile. For example, the shuttle may include a stationary carrying device and a support device that is removably mounted on the stationary carrying device. The stationary carrying device is situated in the vicinity of the positioning device so that the positioning device may dock with the shuttle and the support device may be removed and/or replaced by the positioning device. The stationary carrying device may be used, for example, for support devices, on which QA phantoms are disposed. After the QA measures have been carried out, a support device with QA phantom may be deposited once more onto a stationary carrying device, for example, a shelf-like device disposed on the wall. An unintentional displacement of the support device on the carrying device may occur, so that a desired position of the support device in the room does not always exist.

With the aid of the position detection system, safety and comfort during the docking of the positioning device with the shuttle are markedly increased. For example, when a mobile shuttle is moved into the room of the facility, the shuttle does not have to be positioned exactly in the room to allow the procedure to continue. When a shuttle is not being positioned exactly, the system detects the position of the shuttle and controls the positioning device accordingly. Should the position of the mobile carrying device change, for example, as a result of being knocked accidentally or displaced manually, during an examination/treatment, the change is correspondingly logged and taken into account when the support device is deposited back on the mobile carrying device. In the case of a stationary carrying device and a support device that is not deposited exactly on the stationary carrying device, the position detection system functions in an analogous manner. No hardware other than the position detection system is required. Manual intervention is reduced to a minimum.

The exact interaction of the positioning device with the shuttle allows a substantially steady removal/loading of the support device. As a result, patient safety is increased because, for example, in the case of radiation therapy, shaking of a patient may lead to an undesirable displacement of the patient.

A warning signal may be emitted when it is determined that the shuttle is situated outside of the range of the positioning device. A user may bring the shuttle into a position that is more favorable for the positioning device.

In one embodiment, the positioning device may be a robot arm. The robot arm may be, for example, a six-axis buckling arm robot. The robot arm may increase the mobility and the flexibility of the positioning device.

In one embodiment, the position detection system is an external position detection system. The external position detection system may be used for contactless determination of the position of the shuttle. The position detection system may be disposed in a ceiling area of the room. The ceiling area provides a distance between the position detection system and the shuttle that makes it easy to monitor and determine the position of a shuttle that is moved into the room.

The position detection system may be an electromagnetic position detection system. The position detection system may determine the spatial location of the shuttle with the aid of electromagnetic signals, for example, using at least one radio frequency identification (RFID) transponder.

Alternatively and/or additionally, the position detection system may be an optical position detection system. A localization of the shuttle may be effected, for example, by a laser system, for example, a three-dimensional laser scanner system. The position detection system may include optical cameras. Optical cameras may be used to record and analyze images of the shuttle and determine the location of the shuttle. For example, the position detection system may be a camera system that detects surfaces.

At least one first marker, which is detectable by the position detection system, may be fixed in the room. For example, the at least one first marker may be disposed in a room-fixed manner. The position of the shuttle may be determined in relation to the first room-fixed marker. The precise localization of the shuttle may be facilitated and an adjustment of the position detection system simplified using the stationary reference.

The position detection system may be designed in such a way that the position of the shuttle may be determined by at least one second marker, which is disposed on the shuttle. A marker enables easier automatic localization of the shuttle. For example, a marker may be disposed on a support device and/or other carrying device, for example, if the carrying device is mobile.

Given the use of a plurality of markers, disposed in a room-fixed manner and/or on the shuttle, the localization of the shuttle may be carried out redundantly, which leads to increased safety and accuracy. A combination of different types of detection systems may be used, so that the localization may be determined redundantly in different ways by the various detection systems.

In one embodiment, the position detection system may be designed in such a way that the position of the shuttle, a functional operating state, and/or a type of the shuttle (for example, the type of carrying device and/or the type of support device) may be determined using an additional code. Accordingly, it is possible to establish whether, in the case of a mobile shuttle, the brake is applied or released or whether the support device is locked to the carrying device or unlocked. Control of the positioning device may be carried out in accordance with the additionally determined functional operating state and/or type. The support device may be prevented from being removed from the carrying device if it is established that the support device is locked to the carrying device or, in the case of a mobile shuttle, the shuttle is still in an unbraked state. Control of the positioning device may be carried out as a function of the specific type of support device, when, for example, a plurality of different types of support device, each requiring a slightly different docking of the positioning device, are being used in the medical facility.

The method of docking a positioning device with a shuttle including a support device and a carrying device for the support device, includes disposing the shuttle in a room of a medical facility, determining the position of the shuttle by a position detection system, controlling the positioning device in such a way that during docking of the positioning device with the shuttle, the determined position of the shuttle is used.

The position of the shuttle is determined using at least one first marker, which is disposed in a room-fixed manner, and/or using at least one second marker, which is disposed on the support device, and/or using at least one third marker, which is disposed on the carrying device.

In one embodiment, the method may include determining a functional operating state and/or a type of the shuttle using the position detection system, and controlling the positioning device on the of the determine operating state and/or a type of shuttle.

In another embodiment, the method may include emitting a warning signal during determination of the position when it is established that the shuttle is situated outside of the range of the positioning device.

Developments, such as have been described in detail for the medical facility, may be used also for the method and vice versa.

### BRIEF DESCRIPTION OF THE DRAWINGS

FIG. 1 illustrates one embodiment of a particle therapy facility,

FIG. 2 illustrates one embodiment of a treatment room of a particle therapy facility with a robotic positioning device,

FIG. 3 illustrates one embodiment of a shuttle with markers that are disposed on the shuttle and in the floor area, and

FIGS. 4 and 5 illustrate block diagrams of individual methods carried out during docking operations of the positioning device with the shuttle.

### DETAILED DESCRIPTION

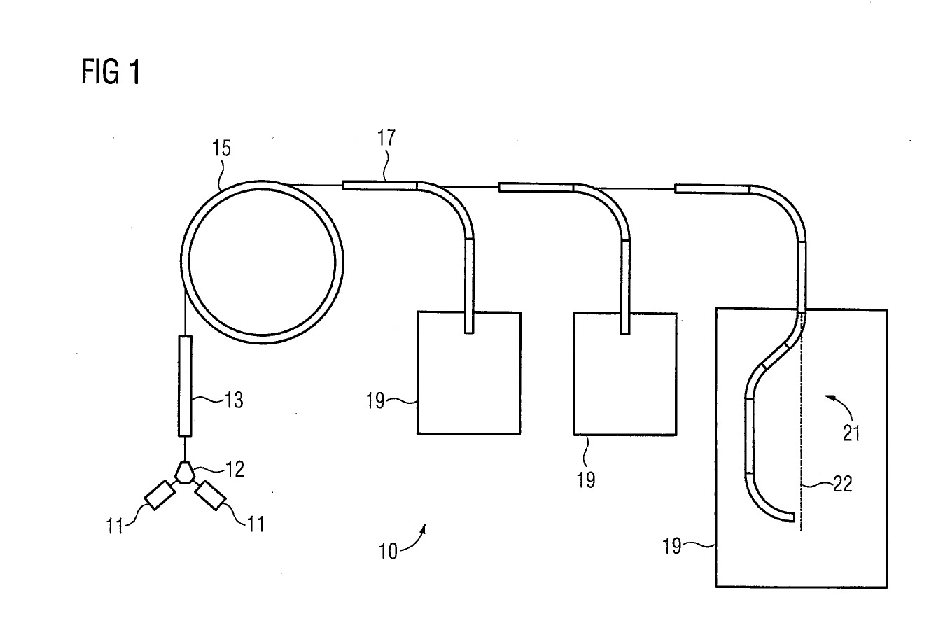

FIG. 1 shows a particle therapy facility 10. The particle therapy facility 10 may be used to irradiate a body, such as tumor-affected tissue, with a particle beam.

The particles may be ions, such as protons, pions, helium ions, carbon ions or other kinds of ions. The particles may be produced in a particle source 11. As shown in FIG. 1, there may be two particle sources 11 producing two different kinds of ions, a switchover between these two kinds of ion may occur within a short interval. A switching magnet 12 may be used for switching. The switching magnet 12 may be disposed between the ion sources 11 and a pre-accelerator 13. Accordingly, for example, the particle therapy facility 10 may be operated simultaneously with protons and with carbon ions.

The ions produced by the ion source 11 or one of the ion sources 11 and selected by the switching magnet 12 are accelerated to a first energy level in the pre-accelerator 13. The pre-accelerator 13 is, for example, a linear accelerator (LINAC, standing for LINear ACcelerator). The particles are then fed into an accelerator 15. The accelerator 15 may be, for example, a synchrotron or cyclotron. In the accelerator 15, the particles are accelerated to the high energies required for irradiation. After the particles have left the accelerator 15, a high-energy beam transfer system 17 carries the particle beam to one or more treatment rooms 19. In a treatment room 19, the accelerated particles are directed onto a body that is to be irradiated. Depending on the design, the direction onto the body occurs from a fixed direction (e.g., in a “fixed-beam” room) or from various directions by a rotatable gantry 21 that is movable about an axis 22.

The layout of a particle therapy facility 10 may be different than that shown in FIG. 1. The exemplary embodiments described below may be used with the particle therapy facility 10 of FIG. 1 or similar particle therapy facilities or in other medical facilities.

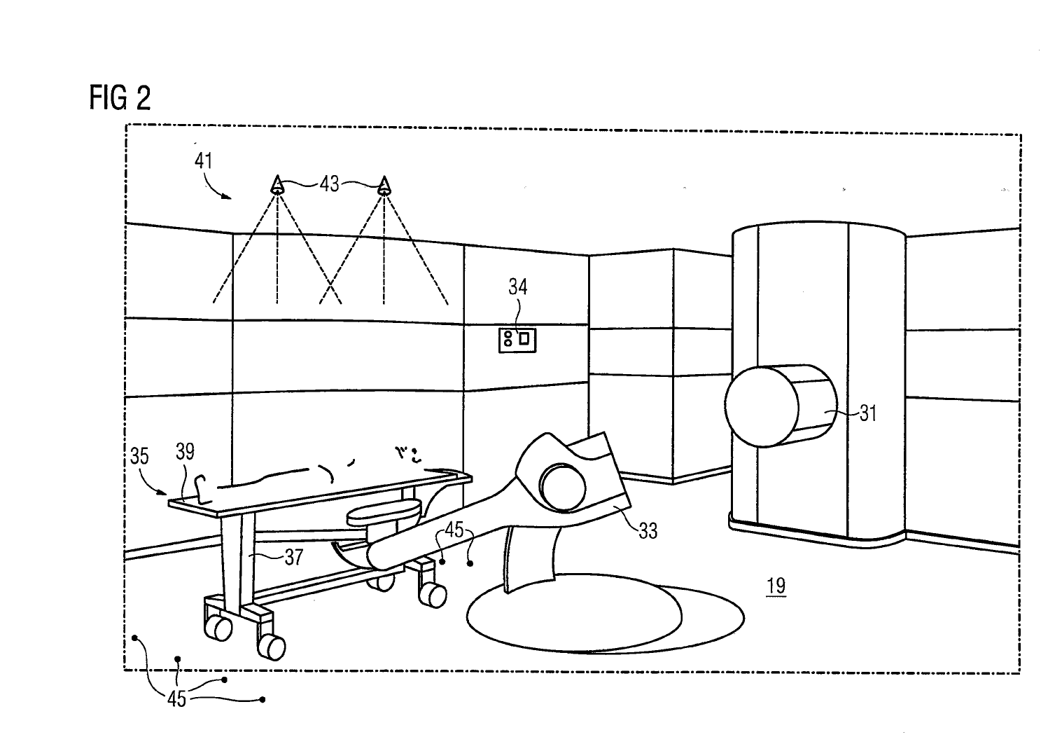

FIG. 2 shows a treatment room 19 in a particle therapy facility. A patient may be irradiated with a particle beam in the treatment room 19. The particle beam, as shown in FIG. 2, may exit from a fixed beam outlet 31. The correct positioning of the patient in relation to the particle beam is undertaken by a robotic positioning device 33. As shown in FIG. 2, the robotic positioning device 33 may include a six-axis buckling arm robot. A control unit 34 may control the robotic positioning device 33.

The preparation of the patient may occur in another room. The patient prepared for an irradiation session is moved into the treatment room 19 by a shuttle 35. The shuttle 35 may include a mobile carrying device 37 and a patient support device, for example, represented as a patient table 39. The patient support device may be mounted on and removable from the mobile carrying device 37. The preparation of the patient may alternatively be carried out in the treatment room 19.

Once the prepared patient is situated on the shuttle 35 in the treatment room 19, the patient table 39 is removed from the mobile carrying device 37 and positioned in the desired manner in the room by the positioning device 33. After irradiation, the patient table 39 is deposited using the positioning device 33 on the mobile carrying device 37.

To enable easy, safe and accurate gripping of the patient table 39 by the positioning device 33, a position detection system 41 is disposed on the ceiling of the treatment room 19. The position detection system 41 may be used to determine the spatial position of the shuttle 35 and, on the basis of the determined spatial position, control the positioning device 33 during docking operations. The position detection system 41 may include two detectors 43, by which the position of the shuttle 35 may be determined redundantly.

The position detection system 41 may detect first markers 45, which are situated in the floor area of the treatment room 19, and/or may detect markers that are disposed on the shuttle 35.

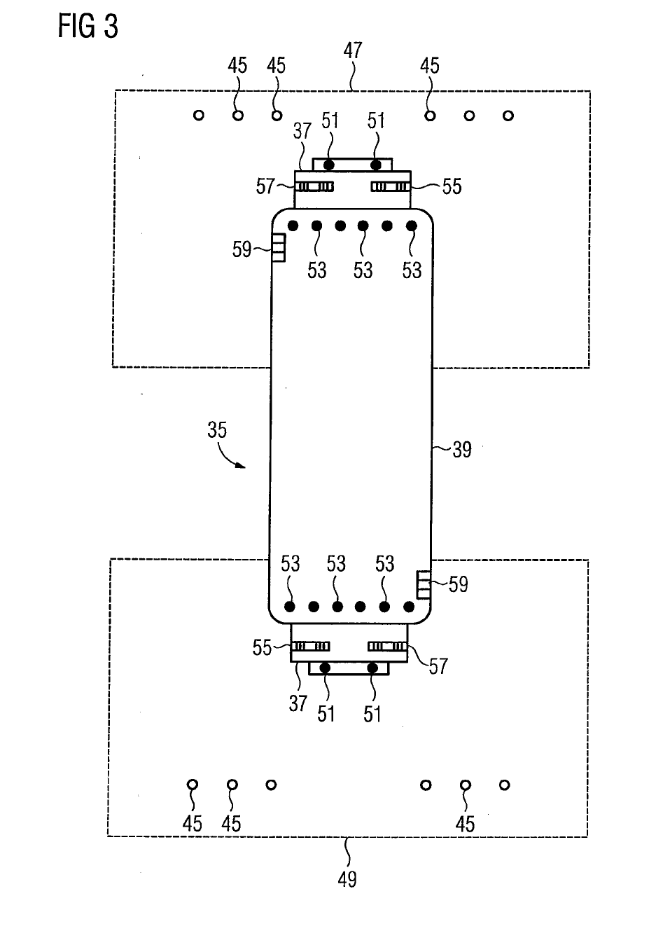

FIG. 3 shows a plan view of a shuttle 35 with a patient table 39. The shuttle 35 may be parked approximately in the region in which the patient table 39 may be gripped by the positioning device 33. The position detection system 41 may scan both the head region 47 and the foot region 49 of the shuttle 35. One of the detectors 43 may be responsible for the head region 47 and the other of the detectors 43 for the foot region 49.

As a spatial reference, the spatial position of room-fixed first markers 45 disposed in the floor area may be used.

The spatial position of second markers 51, which are disposed on the mobile carrying device 37 both in the head region 47 and in the foot region 49, and the spatial position of third markers 53, which are disposed on the patient table 39 in the head—and in the foot region 47, 49, may be determined.

The spatial position of the second markers 51 and the third markers 53 may be related to (i.e. offset against) the spatial position of the room-fixed first markers 45 and so the exact position of the shuttle 35 in the room may be determined.

First codes 55 may be disposed on the shuttle 35. The first codes 55 may identify whether or not the shuttle is in a braked state. Second codes 57 may be disposed on the shuttle 35 and identify whether or not the patient table 39 is locked to the mobile carrying device 37. The first codes 55 and the second codes 57 may be detected by the position detection system 41.

Third codes 59 may be disposed, for example, on the patient table 39. The position detection system 41 may determine the types of patient table 59 and/or the types of mobile carrying device 37 using the third codes 59. This is advantageous if various types of shuttle 35, each requiring a slightly different docking of the positioning device 37, are being used in the medical facility.

The markers/codes 45, 51, 53, 55, 57, 59 may be provided in duplicate and identified redundantly by the two detectors 43 of the position detection system 41, thereby leading to increased safety. However, this is not absolutely essential.

After it has been determined that the shuttle 35 is situated in range of the positioning device 33, and after it has been determined that the shuttle 35 is in the braked state and that the patient table 39 is not locked to the mobile carrying device 37, the positioning device 33 may be controlled such that it removes the patient table 39 from the mobile carrying device 37. If one of the described conditions does not exist, a warning signal may be emitted to allow the user to correct the missing condition. The docking operation may then begin and be controlled on the basis of the determined position and may be controlled on the basis of the determined type of patient table.

The procedure is analogous when the patient table 39 is to be placed back onto the mobile carrying device 37. The position and/or the functional operating state of the mobile carrying device 37, and/or the type of shuttle 35 are detected by the position detection system 43. The positioning device 33 with the patient table 39 is controlled according to the position and/or the functional operating state of the mobile carrying device 37, and/or the type of shuttle 35 are detected by the position detection system 43.

The embodiments described here with reference to a treatment room 19 apply analogously to an examination room, in which, for example, a prepared patient is suitably positioned by the positioning device in a computer tomography scanner for a computer tomography scan examination.

Various embodiments may be used as position detection system 41. In one embodiment, the position detection system 41 may be an electromagnetic position detection system. Electromagnetically operating markers, such as RFID transponders, may be used as markers and/or codes. Optical systems may be equipped, for example, with a laser scanning system. The laser scanning system may be, for example, a three-dimensional laser scanning system. As markers/codes, markers that are detectable by laser beams may be used. If a camera, such as a video camera or a camera that detects surfaces, is used as the optical system, the markers/codes may be designed in such a way that they are detected in a recorded image, for example, using automatic image analysis methods. Also conceivable are systems having ultrasonic sensors for the locating of corresponding markers.

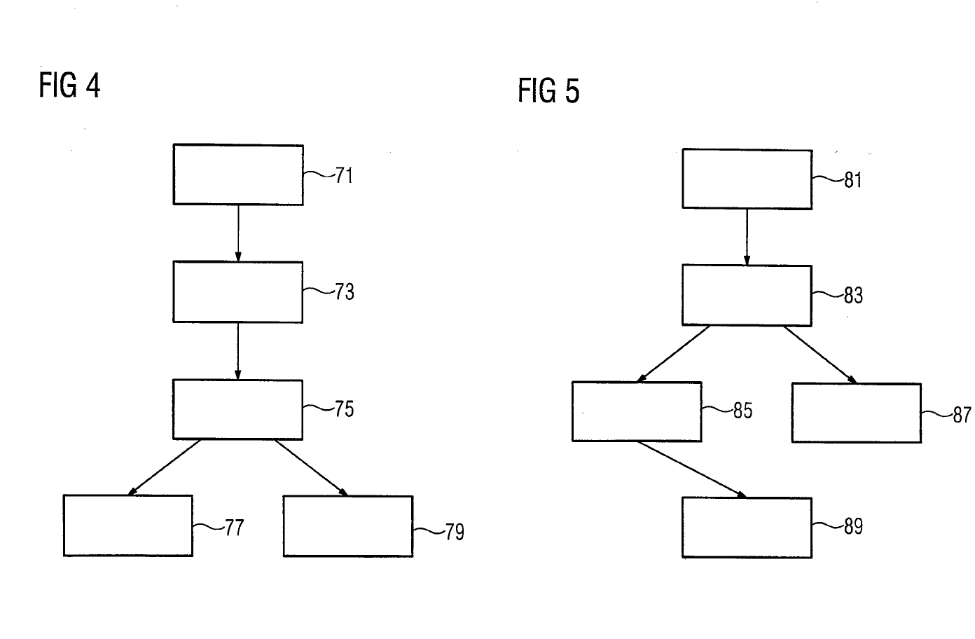

FIG. 4 shows a schematic block diagram of removal method for removing a patient support device from a mobile carrying device. The shuttle may be moved into a room and parked approximately in a region in which the positioning device may dock with the shuttle (act 71). The spatial position of the shuttle is determined (act 73). A functional operating state and/or a type of the shuttle are further determined (act 75). Exemplary states include a braked/unbraked state of the mobile carrying device and a locking/unlocking state between patient support device and mobile carrying device. Other states or types may be determined. If the shuttle is situated at a suitable location and the functional operating state permits, a docking of the positioning device with the shuttle and a removal of the patient support device from the mobile carrying device is performed (act 77). Otherwise, a warning signal is emitted (act 79).

FIG. 5 shows a schematic block diagram of a method for loading the patient support device onto the mobile carrying device. At the end of the treatment/examination, the position of the mobile carrying device is determined (act 81). It is checked whether the mobile carrying device and/or patient support device is in a functional operating state that allows a patient support device to be deposited on the mobile carrying device; optionally, the type of mobile carrying device and/or of patient support device is also determined (act 83). If the mobile carrying device is situated at a suitable location and if a suitable functional operating state exists, the positioning device with the patient support device is docked with the mobile carrying device (act 85). Otherwise, a warning signal is emitted (act 87). After successful loading of the patient support device on the mobile carrying device, the shuttle may be moved out of the room (act 89).

With reference to FIG. 2 to FIG. 5 an embodiment of the invention has been described, in which a mobile shuttle comprising a mobile carrying device and a support device embodied as a patient support device is used. Other embodiments provide that, instead of a patient support device, a support device for QA phantoms may be used. The support device with QA phantoms disposed thereon is positioned at a desired position in the room by the positioning device and the corresponding QA measure is carried out. Instead of the mobile shuttle, it is moreover possible to use a stationary shuttle in the irradiation room. For example, a stationary carrying device, for example, a shelf-like structure, may carry a support device that is removable by the positioning device. In these and other embodiments, the described position detection system may be used for easy and safe docking of the positioning device with the shuttle.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A medical facility comprising:
a room, in which a shuttle having a support device and a carrying device for the support device may be disposed;
a positioning device disposed in the room and designed for docking with the shuttle in such a way that the support device is removable from the carrying device and/or loadable onto the carrying device,
a control unit operable to control the positioning device,
a position detection system operable to determine the spatial position of the shuttle in the room,
wherein the control unit is operable to control the positioning device during docking with the shuttle based on the determined position.

2. The medical facility as claimed in claim 1, wherein the positioning device is a robot arm.

3. The medical facility as claimed in claim 1, wherein the position detection system is an external position detection system for contactless determination of the position of the shuttle.

4. The medical facility as claimed in claim 1, wherein the position detection system is disposed in a ceiling area of the room.

5. The medical facility as claimed in claim 1, wherein the position detection system is an electromagnetic position detection system for spatial localization of the shuttle, the electromagnetic position detection system including at least one radio frequency identification (RFID) transponder.

6. The medical facility as claimed in claim 1, wherein the position detection system is an optical position detection system.

7. The medical facility as claimed in claim 1, wherein in the room at least one first marker is disposed in a room-fixed manner and the position detection system is operable to determine the position of the shuttle in relation to the first room-fixed marker.

8. The medical facility as claimed in claim 7, wherein the position detection system is operable to determine a position of the shuttle using at least one further marker that is disposed on the shuttle.

9. The medical facility as claimed in claim 1, wherein the position detection system is operable to determine a position of the shuttle and a functional operating state and/or a type of the shuttle using a code.

10. A method of docking a positioning device with a shuttle, wherein the shuttle comprises a support device and a carrying device for the support device, the method comprising:
disposing the shuttle in a room of a medical facility,
determining a position of the shuttle using a position detection system, and
controlling the docking of the positioning device with the shuttle based on the determined position of the shuttle.

11. The method as claimed in claim 10, further comprising determining a position of the shuttle using at least one first marker, which is disposed in a room-fixed manner, and using at least one second marker, which is disposed on the carrying device, and using at least one third marker, which is disposed on the support device.

12. The method as claimed in claim 10, further comprising determining a position of the shuttle using:
at least one first marker, which is disposed in a room-fixed manner,
at least one second marker, which is disposed on the carrying device, or
at least one third marker, which is disposed on the support device.

13. The method as claimed in claim 10, wherein the position detection system is operable to determine a position of the shuttle and a functional operating state and/or a type of the shuttle, the positioning device being controlled based on the determined position and the determined function operating state and/or type.

14. The method as claimed in claim 10, further comprising emitting a warning signal when the shuttle is situated outside of a range of the positioning device.

15. The medical facility as claimed in claim 2, wherein the robot arm is a six-axis buckling arm robot.
